(19) United States
(12) Patent Application Publication
(10) Pub. No.: US 2018/0101883 A1
(43) Pub. Date: Apr. 12, 2018

(54) Method of Selling Exterior Iron door with Customized Interchangeable Forged Scrollwork Insert

(71) Applicant: Gary Duncan, Brea, CA (US)

(72) Inventor: Gary Duncan, Brea, CA (US)

(21) Appl. No.: 15/289,682

(22) Filed: Oct. 10, 2016

(51) Int. Cl. G06Q 30/06; G06Q 10/08; B21K 23/00

(52) U.S. Cl. CPC G06Q 30/0621; G06Q 50/08; B21K 23/00; G06Q 10/083

(57) ABSTRACT

A method of selling exterior iron door with customized interchangeable forged scrollwork is completed between a manufacturing company and a consumer. The manufacturing company first ships a specific iron door with an opening, which is selected by the consumer, to the consumer within a shorter time period. As a result, the consumer does not have delay the timeline of the renovation or the construction project and install the specific iron door once it is arrived. A forged scrollwork insert, which is selected by the consumer, is then shipped to the consumer within a longer time period. The longer time period is required by the manufacturing company so that the forged scrollwork insert can be manufactured. Once the consumer receives the forged scrollwork insert, it can be secured to the opening of the specific iron door in order to complete an exterior iron door with customized interchangeable forged scrollwork.

### FIELD OF THE INVENTION

The present invention relates generally to building construction. In particular, the present invention is a method of selling exterior iron doors with customized interchangeable forged scrollwork insert so that the present invention does not hinder a timeline of the construction or renovation project.

### BACKGROUND OF THE INVENTION

Iron doors are used as exterior doors as they provide additional security and aesthetic appearance for many different building structures. Many iron doors are built to stand against coastal hurricanes and other similar natural disasters so that the building structure can be protected in comparison to a regular exterior door. Generally, iron doors take about 8-12 weeks to complete due to their specifications, scrollwork designs, and manufacturing difficulties. As a result, most manufactures have a stock inventory so that the consumer is able to select an iron door from the stock inventory in order to keep up with the construction or renovation project timeline. The biggest problem with this concept is that the consumer is not able to buy a customized iron door from the stock inventory as the customized iron doors take extended time period to manufacture. Resultantly, the consumer purchases a premanufactured and standard iron door since the extended time period of the customized iron door delays the construction or renovation project timeline.

It is therefore an objective of the present invention to introduce a method of selling exterior iron doors with customized interchangeable forged scrollwork insert so that the consumer does not have to delay the construction or renovation project timeline. More specifically, the present invention first supplies the consumer with a blank iron door, without the forged scrollwork, so that the blank iron door can be installed to the building structure. As a result, all the other construction works can take place according to the timeline since the blank iron door is not hindering rest of the construction works. At the same time, the consumer can finalize the customized forged scrollwork for the blank iron door to be manufactured. Once the customized forged scrollwork is completed and supplied to the consumer, the customized forged scrollwork can be installed to the blank iron door. Thus, the consumer is able to install a customized iron door within the building structure without delaying the construction or renovation project timeline.

### BRIEF DESCRIPTION OF THE DRAWINGS

FIG. 1 is a flow chart illustrating the overall process of the present invention.

FIG. 2 is a flow chart illustrating the specification of the specific iron door of the present invention.

FIG. 3 is a flow chart illustrating different methods of selecting the design for the forged scrollwork insert within the overall process of the present invention.

FIG. 4 is a flow chart illustrating the installation of the forged scrollwork insert within the overall process of the present invention.

FIG. 5 is a flow chart illustrating the installation of the screen door within the overall process of the present invention.

### DETAIL DESCRIPTIONS OF THE INVENTION

All illustrations of the drawings are for the purpose of describing selected versions of the present invention and are not intended to limit the scope of the present invention.

The present invention is a method of selling exterior iron door with customized interchangeable forged scrollwork insert. Generally, buying an exterior iron door with customized scrollwork creates two main problems for the consumer. Firstly, the actually buying process usually takes about 8-12 weeks creating a long waiting period. Secondly, the long waiting period forces the consumer to delay or extend the timeline of a renovation or construction project creating additional expenses. However, the present invention is able to resolve both of these problems while providing an exterior iron door with customized scrollwork for the consumer.

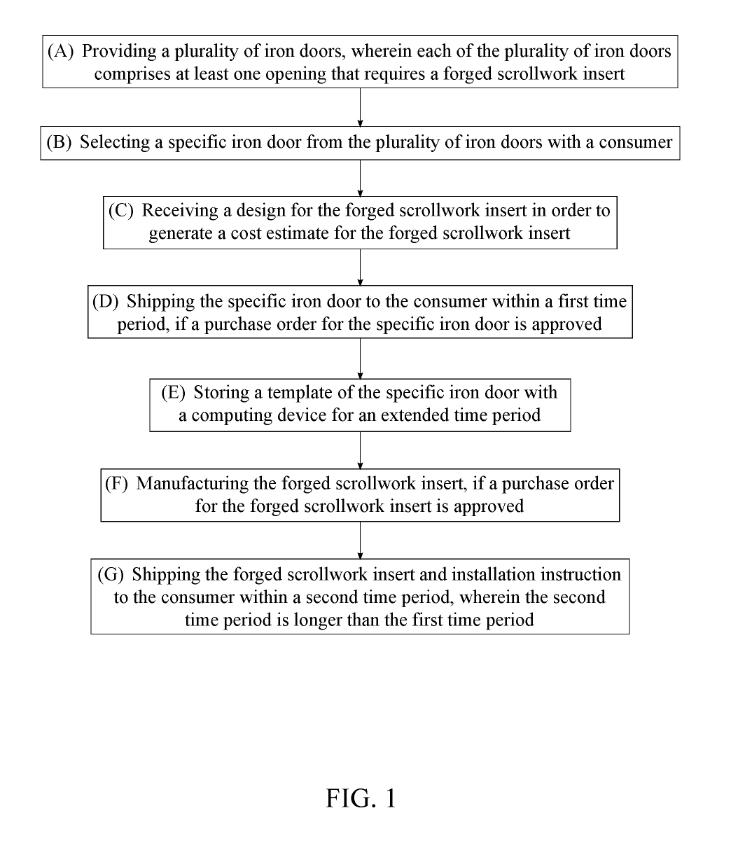

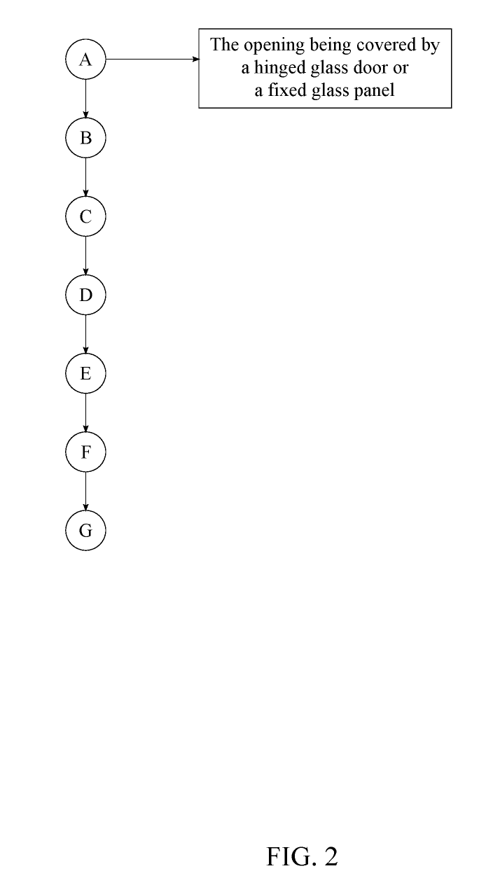

In order to initiate the present invention as shown in FIG. 1, a manufacturing company is required to have an inventory of a plurality of iron door. More specifically, each of the plurality of iron doors comprises at least one opening that requires a forged scrollwork insert. The opening can be positioned within a door panel of each iron door, adjacent to a frame jamb of each iron door, and adjacent to a frame head of each iron door. In reference to FIG. 2, when the opening is positioned within the door panel, each iron door further comprises a hinged glass door to completely cover the opening. When the opening is positioned adjacent to the frame jamb and the frame head, each iron door further comprises a fixed glass panel to completely cover the opening. Furthermore, the plurality of iron doors is required to accommodate different styles, shapes, and sizes so that the plurality of iron doors is able to accommodate a variety of consumer requirements. Since plurality of iron doors allows a wide range of selections, the consumer is able to easily select a specific iron door from the plurality of iron doors, wherein the specific iron door satisfies the consumer requirements. Once the specific iron door is selected, the manufacturing company is able to provide a price for the specific iron door.

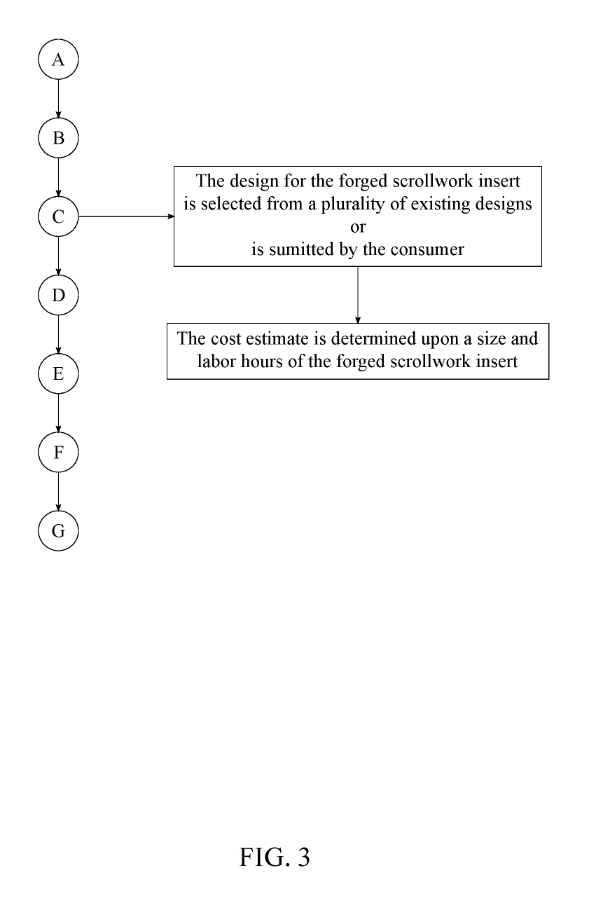

In reference to FIG. 3, the consumer can then select a design for the forged scrollwork insert of the specific iron door. More specifically, the manufacturing company can receive the design for the forged scrollwork insert with two different methods, where one does not proceed the other. Preferably, the consumer can select the design for the forged scrollwork insert from a plurality of existing designs that is given to them by the manufacturing company. However, the consumer is also able to submit his or her drawings as the design for the forged scrollwork insert.

Resultantly, the design for the forged scrollwork insert allows the manufacturing company to generate a cost estimate for the forged scrollwork insert along with the price of the specific iron door. The cost estimate directly relates to a size, labor hours, and number of the forged scrollwork insert that would fit into the opening of the specific iron door. Due to the generated cost estimate and the price of the specific iron door, the consumer is able to determine the total cost of the specific iron door before purchasing the specific iron door.

In reference to FIG. 1, once the consumer is fully satisfied with the cost estimate, the consumer can purchase the specific iron door from the manufacturing company through a purchase order. The manufacturing company then ships the specific iron door to the consumer within a first time period of the present invention if the purchase order is approved and the payment has been credited. The first time period of the present invention is preferably considered as 2-3 business days from the payment approval date. However, the first time period is not limited to 2-3 business days and can be altered by the manufacturing company. Simultaneously, a templet of the specific iron door is stored within a computing device of the manufacturing company for an extended time period. The extended time period is preferably set to 10 years within the present invention; however, it is not limited to 10 years and can be altered by the manufacturing company upon their discretion. As a result of the quick shipping process, the first time period, the consumer can install the specific iron door to the building structure within a relatively short time period without delaying the timeline of the construction or renovation project. The templet allows the manufacturing company to retain specifications of the specific iron door for replacement parts and additional forged scrollwork inserts, creating an efficient post-purchase interaction process between the manufacturing company and the consumer.

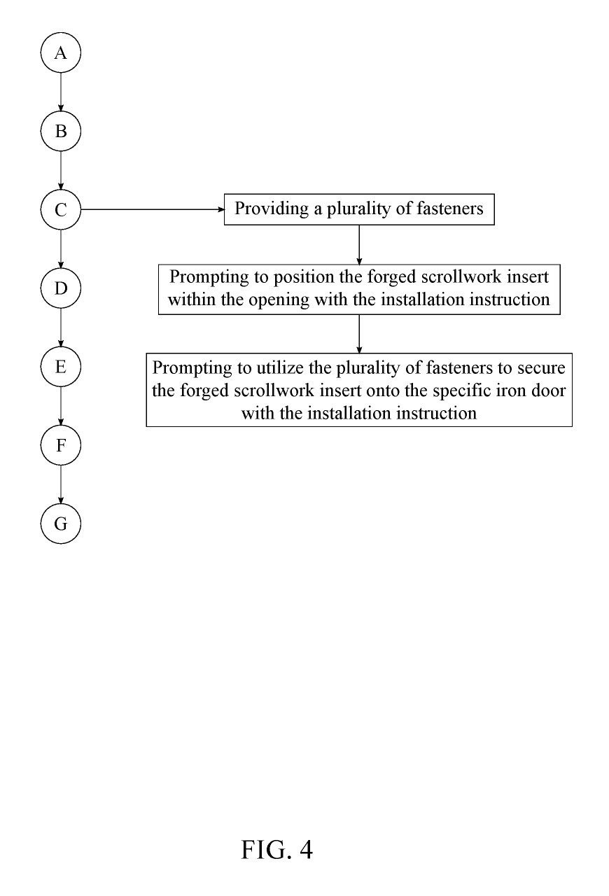

In reference to FIG. 1, once the consumer finalizes the design of the forged scrollwork insert, the consumer can purchase the forged scrollwork insert through a purchase order. More specifically, the manufacturing company starts manufacturing the forged scrollwork insert if the purchase order for the forged scrollwork insert is approved and the payment has been credited. The customization process of the forged scrollwork insert is usually finished within a second time period of the present invention. The second time period that is longer than the first time period and is preferably set to 5-8 weeks from the payment approval date. However, the second time period is not limited to 5-8 weeks and can be altered by the manufacturing company upon their discretion. Once the forged scrollwork insert is completed, the manufacturing company ships the forged scrollwork insert, installation instruction, and a plurality of fasteners to the consumer within the second time period. The installation instruction provides information to the consumer so that the forged scrollwork insert can be correctly installed within the opening. In reference to FIG. 4, the forged scrollwork insert is supposed to be positioned within the opening so that the plurality of fasteners can secure the forged scrollwork insert onto the specific iron door as the plurality of fasteners engages with an edge of the opening. Once the forged scrollwork insert is secured to the specific iron door, the consumer is able to attain an exterior iron door with customized scrollwork. At the same time, the consumer does not have to alter, delay, or extend the timeline of the renovation or construction project.

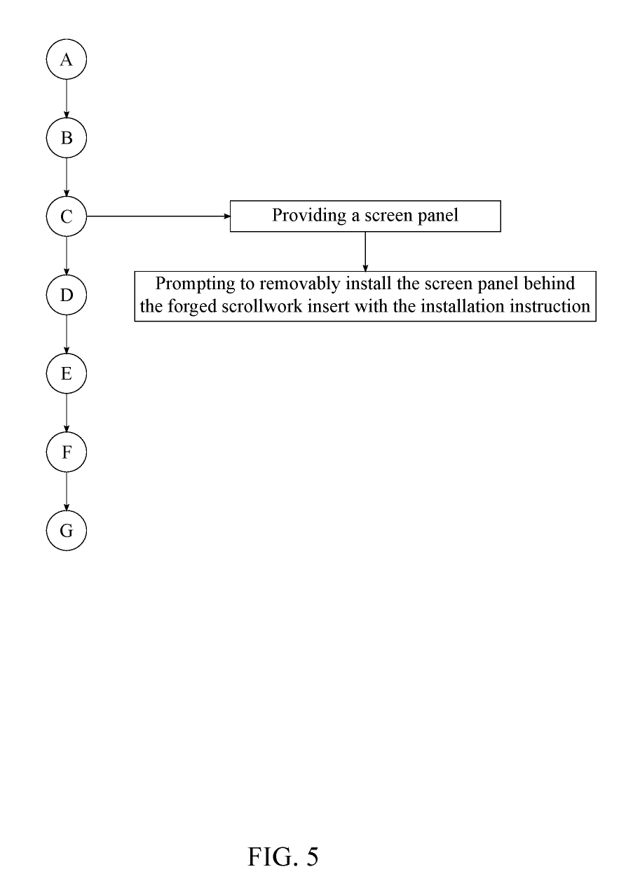

In reference to FIG. 5, the present invention also provides a screen door for the specific iron door. The consumer is able to purchase the screen door form the manufacturing company, wherein the screen door is removably installed behind the forged scrollwork insert and in front of the hinged glass door. Preferably, the screen door is secured with a plurality of magnetic fasteners for easy removal, but the present invention can utilize any other types of easily removable fasteners to secure the screen door. As a result of the screen door, the specific iron door allows the consumer open the hinged glass door without having to worry about flying insects or airborne debris such as seeds or leaves from entering, and pets and small children from exiting interior spaces, while allowing for air, light, and views.

Although the invention has been explained in relation to its preferred embodiment, it is to be understood that many other possible modifications and variations can be made without departing from the spirit and scope of the invention as hereinafter claimed.

What is claimed is:

1. A method of selling exterior iron door with customized interchangeable forged scrollwork comprises the steps of:
(A) providing a plurality of iron doors, wherein each of the plurality of iron doors comprises at least one opening that requires a forged scrollwork insert;
(B) selecting a specific iron door from the plurality of iron doors with a consumer;
(C) receiving a design for the forged scrollwork insert in order to generate a cost estimate for the forged scrollwork insert;
(D) shipping the specific iron door to the consumer within a first time period, if a purchase order for the specific iron door is approved;
(E) storing a template of the specific iron door with a computing device for an extended time period;
(F) manufacturing the forged scrollwork insert, if a purchase order for the forged scrollwork insert is approved; and
(G) shipping the forged scrollwork insert and installation instruction to the consumer within a second time period, wherein the second time period is longer than the first time period.

2. The method of selling exterior iron door with customized interchangeable forged scrollwork as claimed in claim 1, wherein the opening is covered by a hinged glass door.

3. The method of selling exterior iron door with customized interchangeable forged scrollwork as claimed in claim 1, wherein the opening is covered by a fixed glass panel.

4. The method of selling exterior iron door with customized interchangeable forged scrollwork as claimed in claim 1, wherein the designed for the forged scrollwork insert is selected from a plurality of existing designs.

5. The method of selling exterior iron door with customized interchangeable forged scrollwork as claimed in claim 1, wherein the design for the forged scrollwork insert is submitted by the consumer.

6. The method of selling exterior iron door with customized interchangeable forged scrollwork as claimed in claim 1, wherein the cost estimate is determined upon a size and labor hours of the forged scrollwork insert.

7. The method of selling exterior iron door with customized interchangeable forged scrollwork as claimed in claim 1 comprises the steps of:
providing a plurality of fasteners;
prompting to position the forged scrollwork insert within the opening with the installation instruction; and
prompting to utilize the plurality of fasteners to secure the forged scrollwork insert onto the specific iron door with the installation instruction.

8. The method of selling exterior iron door with customized interchangeable forged scrollwork as claimed in claim 1 comprises the steps of:
providing a screen panel; and
prompting to removably install the screen panel behind the forged scrollwork insert with the installation instruction.
